(19) United States
(12) Patent Application Publication
(10) Pub. No.: US 2009/0006451 A1
(43) Pub. Date: Jan. 1, 2009

(54) Web Page-Container Interactions

(75) Inventor: Julio Estrada, Medina, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/771,563

(22) Filed: Jun. 29, 2007

(51) Int. Cl. G06F 17/30; G06F 17/00

(52) U.S. Cl. 707/102; 707/E17.044

(57) ABSTRACT

A method of interaction between a web page and a data container is disclosed. A container may be selected to be viewed on the web page and the container may be displayed in a larger form on the web page. Other items in the container may be expanded on the web page and additional options may be displayed in at least one of the items of the container. If authorization is present, items in the container may be manipulated.

### BACKGROUND

This Background is intended to provide the basic context of this patent application and it is not intended to describe a specific problem to be solved.

Technology has made data more transportable and able to fit on smaller devices. For example, music that previously was stored on compact discs can now be stored as an electronic file on a portable player. Many, many files may be stored on a portable device. As a result, keeping track of data has become increasingly difficult but personalization of the data is possible by creating playlists and adding art. In addition, as the data is easily transferable, there is a desire to share the data with a community. The data may also be difficult to read on a display on a portable computing device meaning that a different display may be need for devices with large screens and devices with smaller screens.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of interaction between a web page and a data container is disclosed. A container may be selected to be viewed on the web page and the container may be displayed in a larger form on the web page. Other items in the container may be expanded on the web page and additional options may be displayed in at least one of the items of the container. If authorization is present, items in the container may be manipulated. Tools may be provided to design displays for web pages and for portable computing devices.

### DRAWINGS

FIG. 1 is an illustration of a container;

FIG. 2 is a flowchart of a method of creating a container of data;

FIG. 3 is an illustration of the architecture of a network for container related activities;

FIG. 4 is a flowchart of a method of displaying a container on a web page;

FIG. 5 is an illustration of an expanded container on a web site; and

FIG. 6 is a flowchart of a method of updating container data.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc., that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

The method may be stored on computer readable media. Computer readable media can be any available media that can be accessed by computer and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

A network may be used as part of the method. The computing devices may operate in a networked environment using logical connections to one or more remote computers. The remote computer may be a personal computer, a server, a router, a network PC, a peer device, a portable media player, a cell phone, or other common network node. The logical connections may include a local area network (LAN) and a wide area network (WAN) but may also include other networks. Such networking environments are commonplace in offices, enterprise-wide computer networks, intranets and the Internet. In a networked environment, program modules depicted relative to the computer, or portions thereof, may be stored in a remote memory storage device.

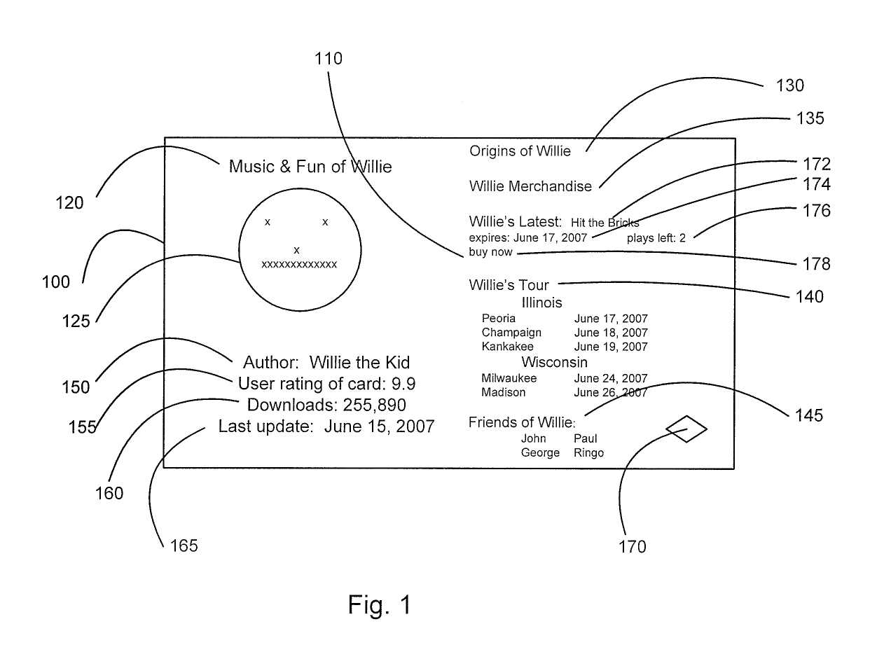

FIG. 1 is an illustration of a sample data container 100. The container 100 may be an electronic collection that contains a variety of data which may or may not have a common theme. In some ways, the container 100 is similar to a folder on a personal computer in that virtually any file may be place in a folder. The container 100 may take on a variety of forms such as being displayed as a card. The variety of possible container 100 forms is limited only by the user's or designer's imagination.

The container 100 may include a variety of items 1 10. The items 110 may be or contain virtually any kind of media or data. Common item 110 examples include a card name 120, a symbol 125, biographical information about a band 130, merchandise available for sale related to the band 135, tour dates of a band 140, friends of the author of the container 145, the author 150, a ratings of the container 155, a number of times the container has been downloaded 160, the date of update of the information 165 in the container 100, etc.

The data in the container may be data related to advertising and the advertising may be related to the other data in the container 100. The advertising may carry referrals to other goods or services. In addition, the advertising may be coupons. In addition, the ability to access and search the container 100 may be part of subscription plan or may be a pay per download plan. Of course, other ways of helping to subsidize the container 100 are possible and are contemplated. As previously stated, the container 100 may contain virtually any data and the previous example is simply an illustration, not a limitation.

The container 100 may have some characteristics that will be further explained in this application. At a high level, the container 100 may be a container 100 in that it may include one or more components such as a bucket can hold water, soap, oil, syrup, a brush, a mop, a tennis ball, etc., either alone or in combination. The container 100 also may be heterogeneous in that it, like the bucket, may hold more than one type of component such as an executable file, a jpeg picture, an avi animation and a Microsoft Word® file. The container 100 may be transportable in that it can travel from one node to another in a wide variety of ways. Any way of communicating data may be used to transport the container 100. The container 100 may also be communicated while online or offline. For example, the container 100 may be stored on a flash memory device and the flash memory device may be in communication with several computers that are not online. The container 100 may be multi-layout capable in that it can be rendered in more than one client or offline network. For example, the container 100 may be viewed on portable media device, a computer, on a portable game, on a cell phone, etc. The container 100 may be “live” in that data in the container 100 may be updated when possible and when appropriate. The container 100 may be shareable in that the share-ability of the container 100 degrades gracefully as the licenses of the content in the container 100 expire or restrictions are triggered. The container 100 is interactive in that it can be browsed and acted upon by selecting items in the container 100. The container 100 may be playable in that items in the container 100 may be selected and played. The container 100 may be social in that it carries information about how it relates to the community in which it lives such as the number of downloads 160, etc. The container 100 may be modified by users in that the container 100 may include content generated or assembled by end users. The container 100 may have a reputation that may be determined by its community. Finally, the container 100 may be monetizable in a variety of ways.

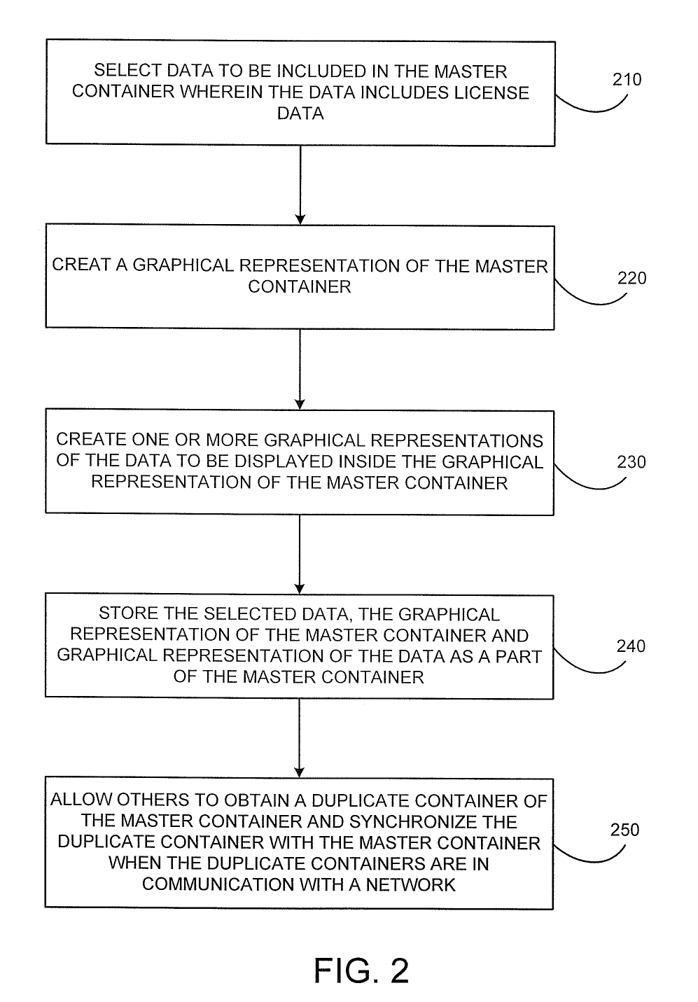

FIG. 2 illustrates a method of creating a container 100 of data. At block 210, data may be selected to be included in the container 100. As previously stated, the data may be any data. Examples include items 110 of interest to the author of the container 100 including music, photos, tour dates, trivia, videos, lyrics, news, etc. In one embodiment, the data includes information about games or games themselves. The selection may be performed through a drag and drop operation or may be performed in virtually any other manner of adding a file to a container 100. In addition, the container 100 may include content generated or assembled by users. For example, an author could include art, animation or movies they created in the container 100. The data in the container 100 may be selectable and may execute an action related to the data selected. For example, the file may be a video file and selecting the file in the container 100 may cause the video file to be displayed. As another example, the file may be an executable file (such as a game) and selecting the file may cause the executable file to be executed (the game would begin). Of course, other actions and file types are possible and are contemplated.

The items 110 may or may not have a common theme. For example, one card may have a college theme related to a specific college. Items 110 on such a card may include the college fight song, videos of the college's band, videos of historic sporting events related to the college, maps of the campus, dates of sporting events for the college, photos of recognizable places on the college campus, games related to the college, etc. On the other hand, another example may have a theme of movies that the user finds amusing. The items 110 may be completely unrelated movies and information related to the actors, directors and producers of these unrelated movies. Of course, these are just examples, and are not meant to be limiting.

The container 100 may be created by an author 150. The author 150 may be an individual, a group of people, a computer program that selects items to be included in a container 100 or a combination thereof. The author 150 may allow others the right to view and modify the container 100. In one embodiment, others may copy some or all of the container 100 and the data therein to create their own container 1 00. In addition, the other users may simply modify the container 100. The author 150 may also have the right to ensure that no one else may modify the container 100 such as by “sealing” the container 100 which means changes cannot be made to the container 100 or copies of the container 100. For example, a music studio may issue a container 100 and the studio may desire that only specific music be items 110 in the container 100. In addition, there may be limited editions of the container 100. For example, a studio may only create 5,000 containers 100 to celebrate an anniversary of a popular album release.

The containers 100 also may have signatures 170 to ensure that the container 100 is authentic. The signature 170 may have a variety of forms from a unique name assigned to the container 100 by a signature authority to an encryption algorithm such as RSA that is used to verify a signature. Of course, virtually any signature would work and is contemplated.

As the data may be copyrighted data such as music, videos, e-books, etc., license information related to the media related data may also be stored in the container 100. Logically, this license information may travel with the container 100 when the container 100 is communicated from one electronic device to another. Also, the share-ability of the items in the container 100 may degrade over time as licenses expire. For example, if a song has a three day/three listen limit before it must be purchased, after the three days, the song may disappear from the container 100. In the embodiment in FIG. 1, a new song (Hit the Bricks) by Willie 172 is displayed. Below the song, the time the license to the song will expire 174 is listed as is the number of plays left 176. In addition, an option is displayed to purchase 178 the song. If the song is purchased, the license rights will change. The license data may be stored in a manner to ensure that the data is not modified without proper authority.

Referring again to FIG. 2, at block 220, a graphical representation of the master container may be created. In one embodiment, the graphical representation looks like a credit card. As previously stated, the container 100 may take on a variety of forms in addition to being displayed as a card. The variety of possible container 100 forms is limited only by the user's or designer's imagination.

At block 230, one or more graphical representations of the data to be displayed may be created inside the graphical representation of the master container 100. For example, the author may desire that the symbol 125 be displayed on the container. Other graphical representations may be added. The graphical representations may be text, numbers, drawings, picture, movies, etc. Common graphical displays may include album covers, movie promos, author information, container 100 name, etc. The graphical representation is similar to a blank canvas to an artist as virtually anything may be displayed on the graphical representation. The graphical representations are limited only by the imagination.

At block 240, the data which may represent items 110 in the master container 100 may be stored with the data being associated with the master container 100. Similar to a folder on a personal computer, the container 100 stores the data inside it and the data is reached through the container 100. The master container 100 may be stored in a variety of locations. The master container 100 may be stored on a central server that is accessible through a network such as the Internet. In addition, the master container 100 may be stored locally or may be accessed through a web site.

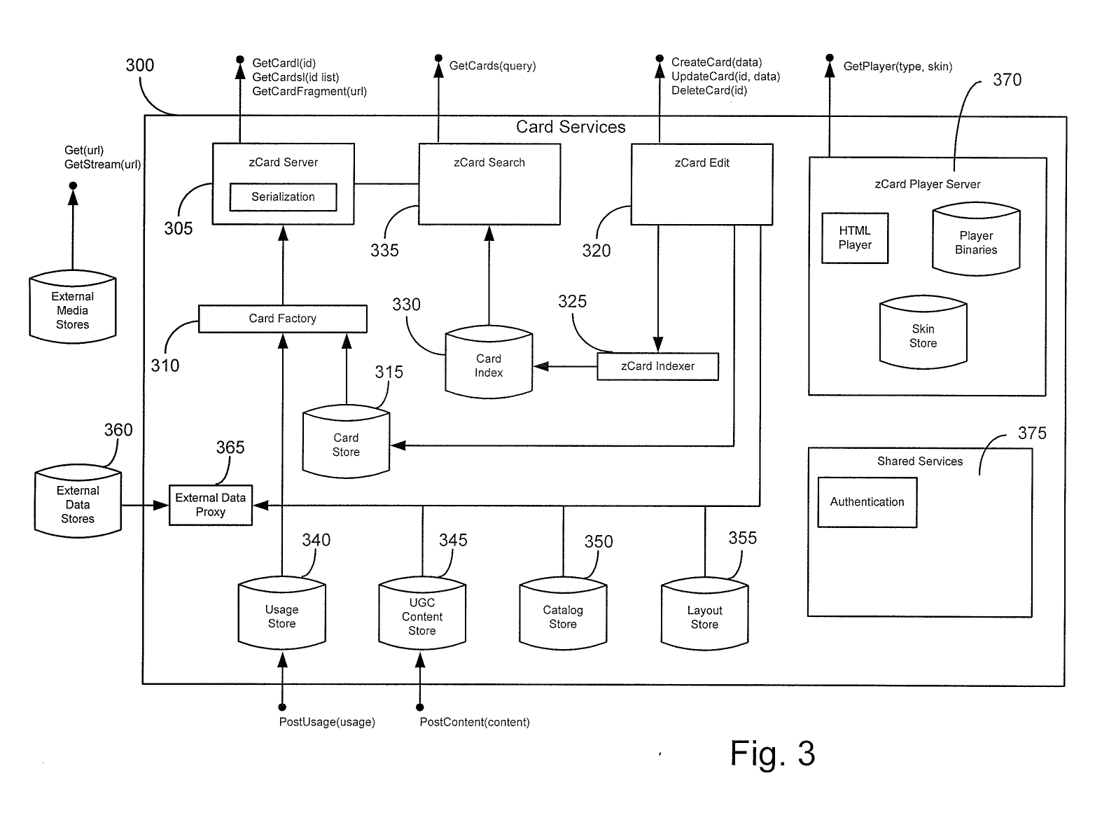

FIG. 3 illustrates an embodiment where a master container 100 is stored on the network 300 and duplicate copies of the container 100 are stored locally. The network may have a container server 305 that stores containers 100 and allows searches of containers 100. Containers 100 (or cards in this example) may be created in a container factory 310. The container factory 310 may obtain data to create containers 100 from a container store 315 which may store previously created containers 100. The containers 100 in the container store 315 may be created using a container editor 320. In the editor 320, cards may be created, updated or deleted. The edited containers 100 may be added to an indexer 325 and stored in an index 330 which may be searched using a container search function 335 which may be accessible to the container server 305. In addition, the card factory 310 may draw from a usage store 340, a user generated content store 345, a catalog store 350, a layout store 355 and from external data stores 360 through a external data proxy 365. External data stores 360 may store the duplicate containers 100 of the master containers 100.

The network 300 may also contain players which may be stored in a player server. Players may include HTML players, player binaries and skin stores. Also, the network 300 may store shared services 375 such as authentication services. Authentication service 375 may be used to authenticate authors to modify sealed containers 100, for example. Another use may be where some services are provided for a fee, the users are authenticated to use the services in which they are entitled.

At block 250, others may be permitted to obtain a duplicate container of the master container. When the duplicate containers are in communication with the network 300, the duplicate container 100 may be synchronized with the master container 100. In one embodiment, changes made to the master container 100 may be communicated to the duplicate copies of the container 100 when the devices on which the duplicate copies of the container 100 are in communication with the network 300. In addition, in some embodiments, changes made to the duplicate copies of the container 100 are added to the master container 100 in a type of wiki fashion, i.e., all the changes and comments by the non-authors are added to the master container 100 for all to see.

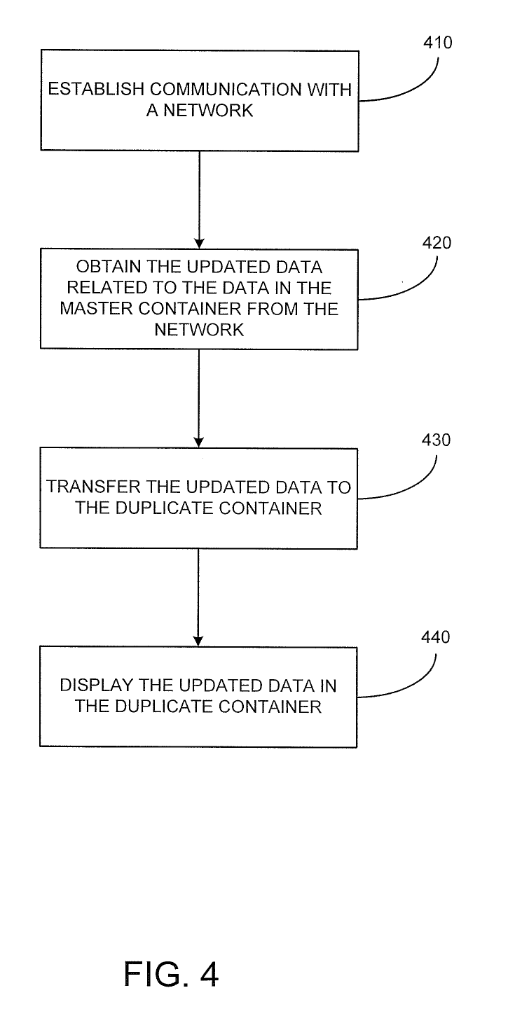

FIG. 4 may illustrate one method of distributing updated items from a master container 100 to a duplicate container 100. At block 410, communicating with a network may be established. The communication may be established in a variety of ways. In one embodiment, the communication is wireless such as communication following IEEE 802.11 guidelines. In another embodiment, the communication is wired over Ethernet. Of course, virtually any communication methodology is possible.

At block 420, updated data related to the data in the container 100 may be obtained from the network. For example, in FIG. 1, additional tour dates may be added to a music tour and tour dates that have passed may be removed from the container 100. The additional tour dates may be added to the container 100 when the container 100 is in communication with the network.

At block 430, the updated data may be transferred to the container 100. The transfer may be communicated in a variety of fashions. By way of example and not limitation, the update may be a packet of data with header information to signify that the packet contains update information. Of course, the ways and manners to transfer data are virtually limitless.

At block 440, the updated data as items in the container 100 may be displayed. In the updated tour dates example, the updated tour dates may be displayed with the other elements of the container 100.

In one embodiment, the container 100 is stored on a web site. Users may be able to review and search for containers 100 using virtually any search criterion, such as the author 150 of the container 100, the name 120 of the container 100 or a word in a song title 172. Users can access the web site through the network 300. Reviewing the container 100 on a web page may present additional options.

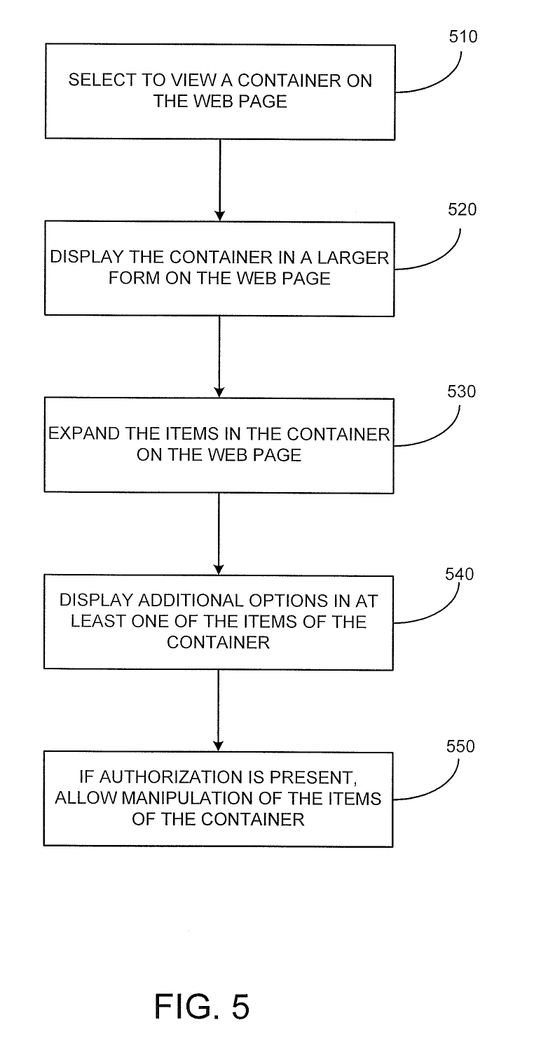

FIG. 5 illustrates a method of interaction between a web page and a media related container 100 where the media related container 100 has a plurality of items 110. At block 510, a container 100 may be selected to be viewed on the web page. The containers 100 may be reviewed, searched or recommended. In some embodiments such as in FIG. 1, the container 100 is viewed as a card and the items 110 on the card are viewed as images on the card. In one embodiment, the card appears to be of a size that would fit in a wallet. A user may design what the container 100 will look like as a card on a portable device and as a web page.

As previously mentioned, the container 100 may be stored in a variety of places and a variety of different data may be stored with the container 100. When the container 100 is stored on the network 300, a wide variety of data and options available along with the container 100. At a home page, statistics related to all users may be present.

At block 520, the container 100 may be displayed in a larger form on the web page. If the container 100 is on a portable media device, the display on the device will be relatively small. If the container 100 is viewed on a larger display such as on a personal computer viewing a web page, the container 100 may be rendered in a larger size. Ideally, images on the container 100 will have sufficient detail that when they are expanded, the images are still identifiable. In addition, some authors will create separate card images card the card itself and when the card is selected to be viewed on a web site.

At block 530, the items in the container 100 on the web page may be expanded. For example, any images on the container 100 may be expanded, lists may be more detailed, additional sections may appear and the network may even add updated or additional information.

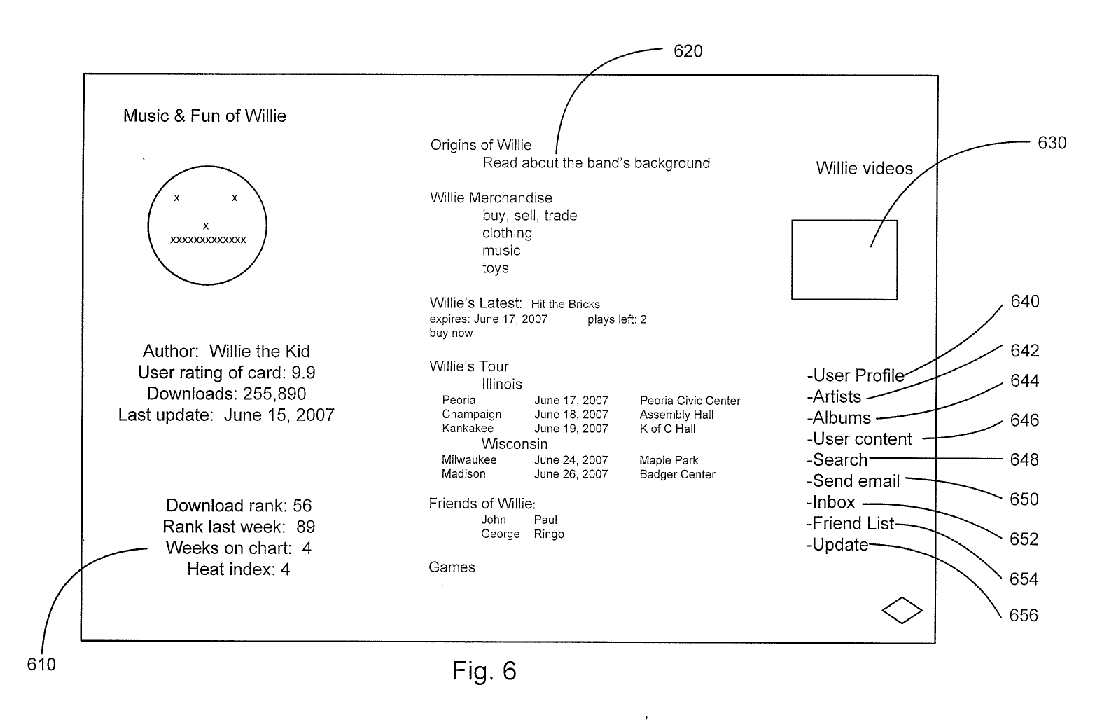

FIG. 6 is an illustration of an embodiment of any expanded card 600. In this embodiment, additional statistics 610 are displayed. In addition, addition items 620 are added and expanded such as the location of the various concerts, games, etc. Videos 630 are added and additional videos may be selected by selecting the video tab. Yet additional items include user profile 640, artists 642, album 644, user content 646, search 648, send email 650, inbox 652, friend list 654 and update 656. In some embodiments, additional information is obtained by selecting one of the items. For example, by selecting user profile 640, additional information may be displayed such as friends, inbox, outbox, usage data, user generated content, etc. Selecting artists 642 or albums 644 may provide additional information such as a marketplace to buy things, editorial data such as ratings, community statistics such as the popularity, and other user generated content. This embodiment is an example and is not intended to be a limitation. Similar to the design of web pages, the variety and type of embodiments of expanded containers 600 are virtually limitless.

If the container 100 is displayed as a card, expanding the card onto a web page may entail selecting the card, displaying a larger version of the images on the card on the web page and displaying additional information related to the images.

Referring again to FIG. 5, at block 540, additional options may be displayed in at least one of the items of the container 100. In one embodiment, the additional options include allowing a user to use authoring tools to add, remove and modify items in the container 100. The modified containers 100 may be saved as new containers 100 with a new name.

At block 550, if authorization is present, manipulation of the items of the container 100 may be allowed. Authorization may be available if the author has not locked or sealed the container 100, for example. If the authorization is available, options may be displayed to add, remove or modify items on the container 100. Authoring tools may be displayed to container allow a user to add, remove and modify items in the container. The tool may have the option to design a container 100 for display on a web site and an additional display for on portable media devices. The tools may make it easier to design containers 100.

If the container 100 is stored locally, it may still be completely operational even though the device storing the container 100 is not in communication with the network. For example, if the container 100 is stored on a portable media device, all the music stored on the container 100 may be played on the portable media device even though the device is not in communication with the network.

A container 100 may be added to a device even if the device is not in communication with the network. Portable media may communicate with the device in question and containers 100 on the portable media may be added to the device. For example, the container 100 may be stored on a flash memory card and the flash memory card may be added to a portable media player. The portable media player may then access the flash memory card and the container 100 may be added to the portable media device. Similarly, a container 100 on a device may be copied to a flash memory device and the flash memory device may be moved to virtual any device that can read the flash memory device and the container 100 may then be moved to that device.

Additional data may be available when the container 100 is viewed on a personal computer. As the processing, display and memory capabilities of portable devices may be limited, not all the options related to the container 100 may be displayed on the portable device. The container 100 when viewed on a personal computer or on a web device that access a web based container 100 may display additional data and options. For example,

The container 100 may be synched whenever it is in communication with an approved network source. For example, the container 100 may contain concert information for a particular music artist. This information may be updated (additional concerts added, opening acts named, etc.) when the device on which the container 100 resides is in communication with an approved network source. Approved network sources may be the Internet which may be accessed through wired or wireless methods. Of course, other networks are possible and are contemplated.

As a result of the method and apparatus described, users can create containers 100 full of data of interest to them. These containers 100 may be posted to a web site where others may share or review the containers 100. The users may then rate the container 100 or add, modify or delete items in the container 100 to create their own container. In addition, if a user appreciates a container 100, changes made to the container 100 by the author may be communicated to the duplicate container 100 whenever the device with the duplicate container 100 is in communication with the original container 100, either directly or through a network. In addition, changes made on the duplicate container 100 may be posted on the original container 100 in a wiki type style. As a result, sharing and communication is increased and it is far easier for people to keep up with other people and the changing tastes in music, fashion, movies, games, etc. The subject of the data exchanged is virtually limitless. In addition, by being able to interact between the container 100 and the network 330 or web pages, changes can be easily made to the containers 100 even if the containers 100 are spread throughout the world and data on container 100 transfers can be collected and used to provide better containers 100 in the future.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of interaction between a web page and a data container wherein the data container has a plurality of items, comprising:
Selecting a container to be viewed on the web page;
Displaying the container in a larger form on the web page;
Expanding the items in the container on the web page;
Displaying additional options in at least one of the items of the container; and
If authorization is present, allowing manipulation of the items of the container.

2. The method of claim 1 wherein expanding the items in the container further comprises displaying additional data related to the items.

3. The method of claim 1, wherein displaying additional options in at least one of the items of the container comprises allowing a user to use authoring tools to add, remove and modify items in the container.

4. The method of claim 1, further comprising if authorization is obtained, copying the container and allowing the container to be modified.

5. The method of claim 1, wherein the container is viewed as a card and the items on the card are viewed as images on the card.

6. The method of claim 5, wherein expanding items in the container on the web page comprises:
selecting the card;
displaying a larger version of the images on the card on the web page; and
displaying additional information related to the images.

7. The method of claim 6, further comprising if proper authorization is available displaying options to add, remove or modify items on the container.

8. The method of claim 1, wherein expanding the items in the container on the web page further comprises:
Communicating with a network;
Obtaining updated data related to the media data in the container;
Transferring the updated data to the container;
Displaying the updated data as items in the container.

9. The method of claim 8, further comprising
Storing the container on a network;
Allowing users beside the author to access the container;
When changes are made to the container by the author, storing the changes on the network;
Distributing the changes to other holders of the container when the other holders connect to the network.

10. The method of claim 9, wherein the changes are made by the author offline and are stored on the network when the device on which the changes were made communicates with the network.

11. The method of claim 1, wherein the container is stored on a network and a user can search for the container among a plurality of containers.

12. The method of claim 1, wherein a user designs what the container will look like as a card and as a web page.

13. A computer storage medium comprising computer executable instructions for controlling interaction between a web page and a data container comprising computer executable instructions for:
Selecting a container to be viewed on the web page;
Displaying the container in a larger form on the web page;
Expanding the items in the container on the web page wherein expanding the items in the container further comprises displaying additional data related to the items;
Displaying additional options in at least one of the items of the container wherein displaying additional options in at least one of the items of the container comprises allowing a user to use authoring tools to add, remove and modify items in the container; and
If authorization is present, allowing manipulation of the items of the container.

14. The computer storage medium of claim 13, wherein the container is viewed as a card and the items on the card are viewed as images on the card and wherein expanding items in the container on the web page comprises:
selecting the card;
displaying a larger version of the images on the card on the web page; and
displaying additional information related to the images.

15. The computer storage medium of claim 13, wherein expanding the items in the container on the web page further comprises:
Communicating with a network;
Obtaining updated data related to the media data in the container;
Transferring the updated data to the container;
Displaying the updated data as items in the container.

16. The computer storage medium of claim 13, further comprising computer executable instructions for:
Storing the container on a network;
Allowing users beside the author to access the container;
When changes are made to the container by the author, storing the changes on the network;
Distributing the changes to other holders of the container when the other holders connect to the network.

17. The computer storage medium of claim 13, wherein the changes are made by the author offline and are stored on the network when the device on which the changes were made communicates with the network.

18. A computer system comprising a processor physically configured to execute computer executable instructions, a memory for assisting in storing and processing computer executable instructions and an input/output circuit, the computer executable instruction comprising instructions for:
Selecting a container to be viewed on the web page;
Displaying the container in a larger form on the web page;
Expanding the items in the container on the web page wherein expanding the items in the container on the web page further comprises:
Communicating with a network;
Obtaining updated data related to the media data in the container;
Transferring the updated data to the container;
Displaying the updated data as items in the container;
Displaying additional options in at least one of the items of the container wherein displaying additional options in at least one of the items of the container comprises allowing a user to use authoring tools to add, remove and modify items in the container; and
If authorization is present, allowing manipulation of the items of the container.

19. The computer system of claim 18, wherein the container is viewed as a card and the items on the card are viewed as images on the card and wherein expanding items in the container on the web page comprises:
selecting the card;
displaying a larger version of the images on the card on the web page; and
displaying additional information related to the images.

20. The computer system of claim 18, further comprising computer executable instructions for:
Storing the container on a network;
Allowing users beside the author to access the container;
When changes are made to the container by the author, storing the changes on the network;
Distributing the changes to other holders of the container when the other holders connect to the network.
